(19) United States
(12) Patent Application Publication
(10) Pub. No.: US 2026/0110277 A1
(43) Pub. Date: Apr. 23, 2026

(54) STIRLING CYCLE HEAT PUMP WITH ACTUATED REGENERATOR AND INTEGRATED DISPLACER

(71) Applicant: Raytheon Company, Tewksbury, MA (US)

(72) Inventors: Andrzej E. Kuczek, Bristol, CT (US); Yasmin Khakpour, South Windsor, CT (US); Matthew R. Pearson, Hartford, CT (US)

(21) Appl. No.: 18/921,756

(22) Filed: Oct. 21, 2024

(51) Int. Cl. F02G 1/057; F02G 1/043

(52) U.S. Cl. CPC F02G 1/057; F02G 1/0435

(57) ABSTRACT

A stirling cycle machine includes a thermal energy exchange apparatus including a first side plate having a plurality of first side pins extending therefrom and a second side plate having a plurality of second side pins extending toward the plurality of first side pins. A regenerator/displacer is positioned between the first side plate and the second side plate. The regenerator/displacer includes a plurality of pin openings, each surrounding a first side pin and a corresponding second side pin. The regenerator/displacer is configured to be driven in a first direction toward the first side plate and in a second direction toward the second side plate. The motion of the regenerator/displacer drives displacement of a working fluid in flow communication with the regenerator/displacer, the first side pins and the second side pins, to urge a thermal energy exchange between the first side pins and the second side pins via the working fluid.

### BACKGROUND

Exemplary embodiments pertain to the art of stirling cycle machines, and in particular to heat pumps operating using a stirling cycle.

A typical stirling cycle heat pump machine includes a cylinder, a working piston, a displacer, and a porous regenerator. The regenerator is a component that stores heat from one cycle so it can be used in the next cycle. Regenerators often include sheets of foil, steel wool, or a metallic sponge disposed therein. The hot working gas flows over the regenerator storing heat from the hot working gas in the regenerator, as the gas flows toward the cold zone. When the cold gas returns, the cold gas flows back over the regenerator and is pre-heated before the gas proceeds back to the hot zone. These typical regenerators, however, often trap a fraction of the working gas, and thus this trapped portion does not participate in the thermal exchange, resulting in an operating efficiency decrease of the heat pump.

### BRIEF DESCRIPTION

In one exemplary embodiment, a stirling cycle machine includes a thermal energy exchange apparatus including a first side plate having a plurality of first side pins extending therefrom and a second side plate having a plurality of second side pins extending toward the plurality of first side pins. A combination regenerator/displacer is positioned between the first side plate and the second side plate. The combination regenerator/displacer includes a plurality of pin openings, each pin opening surrounding a first side pin and a corresponding second side pin. The combination regenerator/displacer is configured to be driven in a first direction toward the first side plate and in a second direction toward the second side plate. The motion of the combination regenerator/displacer drives displacement of a working fluid in flow communication with the combination regenerator/displacer, the first side pins and the second side pins, to urge a thermal energy exchange between the first side pins and the second side pins via the working fluid.

Additionally or alternatively, in this or other embodiments an actuator is operably connected to the combination regenerator/displacer to drive the motion of the combination regenerator between the first side plate and the second side plate.

Additionally or alternatively, in this or other embodiments the actuator is a voice coil actuator.

Additionally or alternatively, in this or other embodiments a displacer shaft operably connects the actuator to the combined regenerator/displacer.

Additionally or alternatively, in this or other embodiments the displacer shaft is positioned at a central axis of the thermal energy exchange apparatus.

Additionally or alternatively, in this or other embodiments an insulator is positioned between each first side pin and the corresponding second side pin.

Additionally or alternatively, in this or other embodiments the first side pins and the second side pins each have a circular cross-sectional shape.

Additionally or alternatively, in this or other embodiments the combined regenerator/displacer is a unitary structure including a body having the plurality of pin openings formed therein.

Additionally or alternatively, in this or other embodiments the first side is defined as a hot side and the second side is defined as a cold side.

Additionally or alternatively, in this or other embodiments a power piston is operably connected to the thermal energy exchange apparatus to one or more of add energy to the stirling cycle machine or remove energy from the stirling cycle machine.

Additionally or alternatively, in this or other embodiments the first side pins, the second side pins, and the combined regenerator/displacer are positioned in a common housing.

In another exemplary embodiment, a method of operating a stirling cycle machine includes providing a first side plate having a plurality of first side pins extending therefrom, providing a second side plate having a plurality of second side pins extending toward the plurality of first side pins, and moving a combination regenerator/displacer between the first side and the second side. The combination regenerator/displacer includes a plurality of pin openings. Each pin opening surrounds a first side pin and a corresponding second side pin. A working fluid in flow communication with the combination regenerator/displacer, the first side pins and the second side pins, is displaced to urge a thermal energy exchange between the first side pins and the second side pins via the working fluid.

Additionally or alternatively, in this or other embodiments the movement of the combination regenerator/displacer is driven via an actuator operably connected to the combination regenerator/displacer.

Additionally or alternatively, in this or other embodiments the actuator is a voice coil actuator.

Additionally or alternatively, in this or other embodiments movement of the combination regenerator/displacer is urged via a displacer shaft operably connecting the actuator to the combination regenerator/displacer.

Additionally or alternatively, in this or other embodiments an insulator is positioned between each first side pin and the corresponding second side pin.

Additionally or alternatively, in this or other embodiments the first side pins and the second side pins each have a circular cross-sectional shape.

Additionally or alternatively, in this or other embodiments the combined regenerator/displacer is a unitary structure including a body having the plurality of pin openings formed therein.

Additionally or alternatively, in this or other embodiments a power piston is operably connected to the thermal energy exchange apparatus to one or more of add energy to the stirling cycle machine or remove energy from the stirling cycle machine.

Additionally or alternatively, in this or other embodiments the first side pins, the second side pins, and the combined regenerator/displacer are disposed in a common housing.

### BRIEF DESCRIPTION OF THE DRAWINGS

The following descriptions should not be considered limiting in any way. With reference to the accompanying drawings, like elements are numbered alike:

FIG. 1 is a partial cross-sectional view of an embodiment of a heat pump;

FIG. 2 is a cross-sectional view of a pin arrangement of an embodiment of a heat pump;

FIG. 3 is another cross-sectional view of a pin arrangement of a heat pump; and

FIG. 4 is yet another cross-sectional view of a pin arrangement of a heat pump.

### DETAILED DESCRIPTION

A detailed description of one or more embodiments of the disclosed apparatus and method are presented herein by way of exemplification and not limitation with reference to the Figures.

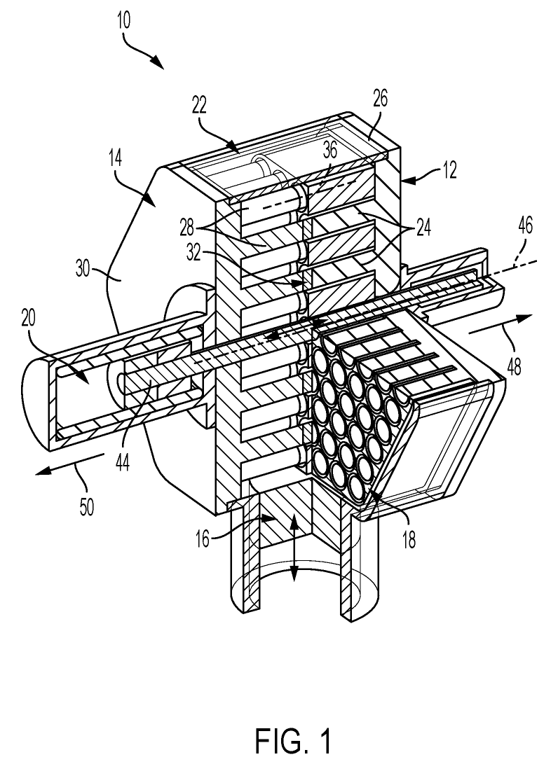

Illustrated in FIG. 1 is an exemplary embodiment of a stirling cycle machine 10. The machine 10 generally includes a hot side 12, a cold side 14 opposite the hot side 12, a power piston 16 and a combination regenerator/displacer 18. The regenerator/displacer 18 is moved between the hot side 12 and the cold side 14 via an actuator 20 operably connected to the regenerator/displacer 18. In some embodiments, the actuator 20 is a voice coil actuator 20. The hot side 12, the cold side 14 and the regenerator/displacer 18 are positioned in a machine housing 22.

The hot side 12 includes a plurality of hot side pins 24 extending from a hot side plate 26 toward the cold side 14. In some embodiments, the hot side pins 24 are circular in cross-section and extend parallelly toward the cold side 14. Hot side pins 24 having circular cross-sections are merely exemplary, however, and one skilled in the art will readily appreciate that the hot side pins 24 may have other cross-sectional shapes, such as rectangular, hexagonal, or other polygonal shapes. Additionally, the hot side pins 24 may vary in cross-sectional size and/or shape along their length, and adjacent hot side pins 24 may be identical or alternatively may differ in cross-sectional size and/or shape.

Similarly, the cold side 14 includes a plurality of cold side pins 28 extending from a cold side plate 30 toward corresponding hot side pins 24 of the machine 10. In one embodiment, the cold side plate 30 is positioned parallel to the hot side plate 26. In some embodiments, the cold side pins 28 are circular in cross-section and extend parallelly toward the cold side 14. Cold side pins 28 having circular cross-sections are merely exemplary, however, and one skilled in the art will readily appreciate that the cold side pins 28 may have other cross-sectional shapes, such as rectangular, hexagonal, or other polygonal shapes. Additionally, the cold side pins 28 may vary in cross-sectional size and/or shape along their length, and adjacent cold side pins 28 may be identical or alternatively may differ in cross-sectional size and/or shape. In some embodiments, the cold side pins 28 have identical cross-sectional shapes and sizes to corresponding hot side pins 24. An insulator 32 is positioned between each cold side pin 28 and the corresponding hot side pin 24 along a pin axis 36 of the machine 10. The hot side pins 24 and the cold side pins 28 are formed from a highly conductive material such as, for example, copper.

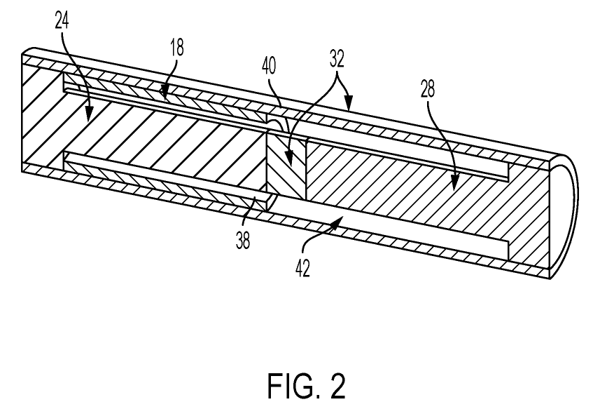

The regenerator/displacer 18 is a honeycomb-like structure including a plurality of pin openings 38 surrounding each of the hot side pin 24 and cold side pin 28 combinations. A pin insulator 40, as illustrated in FIG. 2, surrounds the regenerator/displacer 18 at each of the pin combinations, and defines a working gas space 42 between the pins 24/28 and the pin insulator 40 with the regenerator/displacer 18 positioned in the working gas space 42. In some embodiments, the regenerator/displacer 18 is formed from a metal material, such as aluminum or an aluminum alloy. Referring again to FIG. 1, the regenerator/displacer 18 is secured to a displacer shaft 44, which is translatable along a shaft axis 46, which is parallel to the pin axis 36. The displacer shaft 44 is secured to the regenerator/displacer 18 such that movement of the displacer shaft 44 along the shaft axis 46 likewise translates the regenerator/displacer 18 along the shaft axis 46. In some embodiments, such as shown in FIG. 1, the displacer shaft 44 is located at a center of the machine 10, while in other embodiments, the displacer shaft 44 may be positioned in other locations, such as at an outer rim of the machine 10.

The actuator 20 is operably connected to the displacer shaft 44 to urge the movement of the displacer shaft 44 and thus movement of the regenerator/displacer 18 along the shaft axis 46 in both a first axial direction 48 and a second axial direction 50 opposite the first axial direction 48. In one embodiment, the actuator 20 is a voice coil actuator 20. A voice coil actuator 20 is also known as a non-commutated DC linear actuator, is a type of direct drive linear motor. The voice coil actuator 20 enables change of the operational characteristics of the regenerator/displacer 18 from the typical sinusoidal wave form toward a trapezoidal wave form allowing for more residence time of the regenerator/displacer 18 at each of the hot side 12 and the cold side 14 and great control of phase shift of the motion of the regenerator/displacer 18 relative to motion of the power piston 16. While in some embodiments, the regenerator/displacer 18 is connected to the actuator 20 via a displacer shaft, in other embodiments the regenerator/displacer 18 is suspended by one or more flexible elements, such as spring elements or the like, and is moved along the axis 46 by an external magnetic field emitted from the actuator 20.

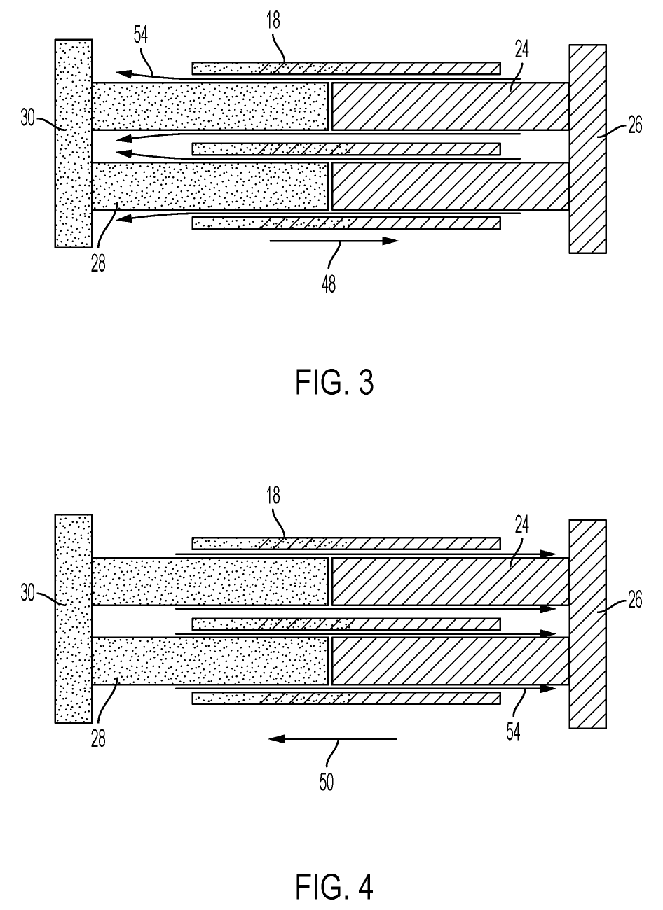

Referring now to FIG. 3, during operation of the actuator 20, the regenerator/displacer 18 is moved in the first axial direction 48 toward the hot side 12. This urges a working gas 54 contained in the working gas space 42 from the hot side 12 toward the cold side 14 for thermal energy transfer with the cold side pins 28 and the cold side plate 30 to cool the working gas 54. Similarly, as shown in FIG. 4, when the motion of the regenerator/displacer 18 is reversed and the regenerator/displacer 18 is moved toward the cold side 14, the working gas 54 is urged from the cold side 14 toward the hot side 12 for thermal energy exchange with the hot side pins 24 and the hot side plate 26, increasing a temperature of the working gas 54. As can be seen from FIG. 3 and 4, the working gas 54 is not trapped in the regenerator/displacer 18, but can participate fully in the thermal energy exchange, thus improving the operating efficiency of the machine 10.

The combined regenerator/displacer 18 actively displaces the working gas 54 from the cavity of the hot side 12 and the cold side, with the regenerator/displacer 18, the hot side pins 24 and the cold side pins 28 providing a large surface area necessary for effective heat transfer in the machine 10. Use of the combined regenerator/displacer 18 results in an increase in cryocooling cycle efficiency in applications such as liquid hydrogen production and storage, and can also be used in high-temperature superconductivity systems. Additionally. Such configurations may be utilized to improve cooling of systems such as, radiation detection systems, optics systems, and electronics systems. Further, the configurations may provide relatively low cost and compact general refrigeration and cooling solutions, and may also be utilized to provide quiet propulsion and increased battery capacity in applications such as unmanned underwater vehicles (UUV’s).

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A stirling cycle machine comprising:
a thermal energy exchange apparatus including:
a first side plate having a plurality of first side pins extending therefrom;
a second side plate having a plurality of second side pins extending toward the plurality of first side pins; and
a combination regenerator/displacer positioned between the first side plate and the second side plate, the combination regenerator/displacer including a plurality of pin openings, each pin opening surrounding a first side pin and a corresponding second side pin;
wherein the combination regenerator/displacer is configured to be driven in a first direction toward the first side plate and in a second direction toward the second side plate, the motion of the combination regenerator/displacer driving displacement of a working fluid in flow communication with the combination regenerator/displacer, the first side pins and the second side pins, to urge a thermal energy exchange between the first side pins and the second side pins via the working fluid.

2. The stirling cycle machine of claim 1, further comprising an actuator operably connected to the combination regenerator/displacer to drive the motion of the combination regenerator between the first side plate and the second side plate.

3. The stirling cycle machine of claim 2, wherein the actuator is a voice coil actuator.

4. The stirling cycle machine of claim 2, further comprising a displacer shaft operably connecting the actuator to the combined regenerator/displacer.

5. The stirling cycle machine of claim 4, wherein the displacer shaft is disposed at a central axis of the thermal energy exchange apparatus.

6. The stirling cycle machine of claim 1, further comprising an insulator disposed between each first side pin and the corresponding second side pin.

7. The stirling cycle machine of claim 1, wherein the first side pins and the second side pins each have a circular cross-sectional shape.

8. The stirling cycle machine of claim 1, wherein the combined regenerator/displacer is a unitary structure including a body having the plurality of pin openings formed therein.

9. The stirling cycle machine of claim 1, wherein the first side is defined as a hot side and the second side is defined as a cold side.

10. The stirling cycle machine of claim 1, further comprising a power piston operably connected to the thermal energy exchange apparatus to one or more of add energy to the stirling cycle machine or remove energy from the stirling cycle machine.

11. The stirling cycle machine of claim 1, wherein the first side pins, the second side pins, and the combined regenerator/displacer are disposed in a common housing.

12. A method of operating a stirling cycle machine comprising:
providing a first side plate having a plurality of first side pins extending therefrom;
providing a second side plate having a plurality of second side pins extending toward the plurality of first side pins;
moving a combination regenerator/displacer between the first side and the second side, the combination regenerator/displacer including a plurality of pin openings, each pin opening surrounding a first side pin and a corresponding second side pin; and
displacing a working fluid in flow communication with the combination regenerator/displacer, the first side pins and the second side pins, to urge a thermal energy exchange between the first side pins and the second side pins via the working fluid.

13. The method of claim 12, further comprising driving the movement of the combination regenerator/displacer via an actuator operably connected to the combination regenerator/displacer.

14. The method of claim 13, wherein the actuator is a voice coil actuator.

15. The method of claim 13, further comprising urging movement of the combination regenerator/displacer via a displacer shaft operably connecting the actuator to the combination regenerator/displacer.

16. The method of claim 12, further comprising positioning an insulator between each first side pin and the corresponding second side pin.

17. The method of claim 12, wherein the first side pins and the second side pins each have a circular cross-sectional shape.

18. The method of claim 12, wherein the combined regenerator/displacer is a unitary structure including a body having the plurality of pin openings formed therein.

19. The method of claim 12, further comprising operably connecting a power piston to the thermal energy exchange apparatus to one or more of add energy to the stirling cycle machine or remove energy from the stirling cycle machine.

20. The method of claim 12, wherein the first side pins, the second side pins, and the combined regenerator/displacer are disposed in a common housing.
